(19) United States
(12) Patent Application Publication
(10) Pub. No.: US 2022/0113673 A1
(43) Pub. Date: Apr. 14, 2022

(54) METHOD AND DEVICE FOR TRANSMITTING DATA REPRESENTING A DIGITAL HOLOGRAM

(71) Applicant: FONDATION B-COM, Cesson-Sévigné (FR)

(72) Inventors: Anas EL RHAMMAD, Rennes (FR); Antonin GILLES, Rennes (FR); Patrick GIOIA, SERVON-SUR-VILAINE (FR); Marco CAGNAZZO, GIF-SUR-YVETTE (FR)

(21) Appl. No.: 17/427,041

(22) PCT Filed: Jan. 29, 2020
(86) PCT No.: PCT/FR2020/050140

§ 371 Date: Nov. 17, 2021

(30) Foreign Application Priority Data
Jan. 30, 2019 (FR) 1900838

(51) Int. Cl. G03H 1/08

(52) U.S. Cl. CPC G03H 1/0891; G03H 1/0808

(57) ABSTRACT

A method for transmitting data representative of a digital hologram represented by a set of atoms each having a diffraction spectrum in a plane of observation includes the following steps: determining an order for sets each including at least one atom, as a function of a distance, in the plane of observation, between a position of observation and a position associated to the involved set; and transmitting, for a part at least of the sets and in the determined order, descriptive data of the at least one atom included in the involved set. An associated transmission device is also described.

### BACKGROUND OF THE INVENTION

### Field of the Invention

The present invention generally relates to the technical field of digital holograms.

It relates in particular to a method and a device for transmitting data representative of a digital hologram.

### Description of the Related Art

It has been proposed to represent a digital hologram by means of atoms located in the plane of the hologram and each representing a light contribution linked to a particular wavelet (in practice a Gabor wavelet).

When the digital hologram has to be reconstructed by means of a remote holographic display, descriptive data of these atoms are transmitted, which comprise, for example, for each atom: the position of this atom in the plane of the hologram, the coefficient associated with this atom and values defining the Gabor wavelet associated with this atom.

In order to limit the quantity of information to be transmitted, it has been proposed in document WO 2015/097 358 to transmit only the data relating to Gabor wavelets whose emission cone has an intersection with a volume linked to the observer.

### SUMMARY OF THE INVENTION

In this context, the invention proposes a method for transmitting data representative of a digital hologram represented by a set of atoms each having a diffraction spectrum in a plane of observation, comprising the following steps:
determining an order for sets each including at least one atom, as a function of a distance, in the plane of observation, between a position of observation and a position associated with the involved set;
transmitting, for a part at least of said sets and in the determined order, descriptive data of said at least one atom included in the involved set.

The atoms are hence ordered as a function of the interest they have for the reconstruction of the digital hologram at the position of observation (which is the position from which the digital hologram is viewed). The first data transmitted are hence the most relevant and allow a rapid acceptable reconstruction of the digital hologram. This reconstruction can then be improved when the subsequent data are received. The quantity of transmitted data can further be adapted as a function of the circumstances (for example, the rate available on the communication network used).

As explained hereinafter, each above-mentioned set can include a single atom (as in the first embodiment described hereinafter) or a variable number of atoms (as in the second embodiment described hereinafter).

The method defined hereinabove can comprise a previous step of receiving data representative of the position of observation in the plane of observation.

According to a first possibility, each set can include a single atom; it can then be provided that the position associated with the involved set is the position of the center of the diffraction spectrum (in the plane of observation) of the atom included in the involved set.

The order can also be determined as a function of an angular dispersion or an amplitude associated with the atom included in the involved set.

The descriptive data of the atom that are transmitted can moreover include data representative of the position of the center of the diffraction spectrum of this atom in a viewing window linked to the position of observation. The quantity of data to be transmitted to represent the position of the involved atom is hence reduced.

According to a second possibility, each set includes the atom having a diffraction spectrum whose center is located in a corresponding region (for example a block) of the plane of observation.

In this case, the position associated with the involved set is for example the center of the region corresponding to said involved set.

The descriptive data of at least one atom included in the involved set can then comprise data representative of the position of the center of the diffraction spectrum of this atom in the region corresponding to the involved set. The quantity of data to be transmitted to represent the position of the involved atom is hence reduced.

The method can then comprise a step of transmitting data representative of the position of said region in the plane of observation.

Moreover, it can then be provided a previous step of associating each atom with the region (for example the block) of the plane of observation that contains the center of the diffraction spectrum of this atom.

The method can also comprise, for at least one given region of the plane of observation, a step of ordering the atoms associated with said given region as a function of an angular dispersion or an amplitude associated with each of these atoms.

The invention also proposes a device for transmitting data representative of a digital hologram represented by a set of atoms each having a diffraction spectrum in a plane of observation, comprising:
a determination module for determining an order for sets each including at least one atom, as a function of a distance, in the plane of observation, between a position of observation and a position associated with the involved set; and
a transmission module for transmitting, for a part at least of said sets and in the determined order, descriptive data of said at least one atom included in the involved set.

Such a device can include a module for receiving data representative of the position of observation in the plane of observation.

As already indicated, each set can include a single atom; the determination module is then, for example, designed to determine the order among said sets as a function of the distance, in the plane of observation, between a position of observation and the position of the center of the diffraction spectrum of the atom included in the involved set.

The transmission module can be designed to transmit data representative of the position of the center of the diffraction spectrum of said at least one atom in a viewing window linked to the position of observation.

As already indicated, according to another possibility, each set can include the atoms having a diffraction spectrum whose center is included in a corresponding region (for example a block) of the plane of observation; the determination module can then be designed to determine the order among said sets as a function of the distance, in the plane of observation, between a position of observation and the center of the region corresponding to said involved set.

The transmission module can then be designed to transmit data representative of the position of the center of the diffraction spectrum of said at least one atom in the region corresponding to the involved set.

In this case, it can also be provided a module for associating each atom with the region of the plane of observation containing the center of the diffraction spectrum of this atom.

It is also proposed, in an original manner per se, a method for transmitting data representative of a digital hologram represented by a set of Gabor atoms each having a diffraction spectrum in a plane of observation, comprising the following steps for transmitting descriptive data of a given Gabor atom:
transmitting data representative of the position of the center of the diffraction spectrum of the given atom in the plane of observation;
transmitting characteristic data of the Gabor wavelet associated with the given atom.

These characteristic data define for example an index of dilation and index of rotation associated with the given atom.

As explained hereinafter, it is indeed possible, using the characteristics of the Gabor wavelet and the position of the diffraction spectrum center, to find the position associated with the given atom in the plane of the digital hologram (also taking into account the distance between the plane of observation and the plane of the digital hologram, represented for example by an ordinate z_{O} and potentially previously received at the two transmission steps mentioned hereinabove, for example at receipt of data representative of a position of observation x_{O}, y_{O}, z_{O}).

The characteristic data can also define a coefficient (typically a complex coefficient) associated with the atom and used for reconstructing the hologram as explained hereinafter.

It is hence also proposed, within this framework, a method for receiving data representative of a digital hologram represented by a set of Gabor atoms each having a diffraction spectrum in a plane of observation, comprising the following steps, at receipt of descriptive data of a given Gabor atom:
receiving characteristic data of the Gabor wavelet associated with the given atom and data representative of the position of the center of the diffraction spectrum of the given atom in the plane of observation;
determining the position of the given atom in the plane of the digital hologram as a function of said representative data and said characteristic data.

It is hence possible, at receipt, to reconstruct the digital hologram on the basis notably of the position of the atom in the plane of a digital hologram.

Of course, the different features, alternatives and embodiments of the invention can be associated with each other according to various combinations, insofar as they are not mutually incompatible or exclusive.

### BRIEF DESCRIPTION OF THE DRAWINGS

Moreover, various other features of the invention will be apparent from the appended description made with reference to the drawings that illustrate non-limitative embodiments of the invention, and wherein:

FIG. 1 shows an atom of a digital hologram and its diffraction spectrum in a plane of observation;

FIG. 2 shows a data exchange system according to a first embodiment of the invention;

FIG. 3 shows the main steps of an exemplary data transmission method in accordance with the first embodiment;

FIG. 4 shows a data exchange system according to a second embodiment of the invention;

FIG. 5 illustrates an exemplary cutting of a plane of observation used in this second embodiment; and

FIG. 6 shows the main steps of an exemplary data transmission method in accordance with the second embodiment.

### DESCRIPTION OF THE PREFERRED EMBODIMENTS

In the following, we will consider a digital hologram H of resolution (Nₓ, N_{y}) represented by a set A_{K} of atoms (here Gabor atoms) aₖ each corresponding to a light contribution linked to a particular wavelet (here a Gabor wavelet). For purposes of this disclosure, the term atom is used as it is defined in the article “The Work of Yves Meyer”, by I. Daubechies, in Proceedings of the International Congress of Mathematicians, Hyderabad, 2000, p. 120.

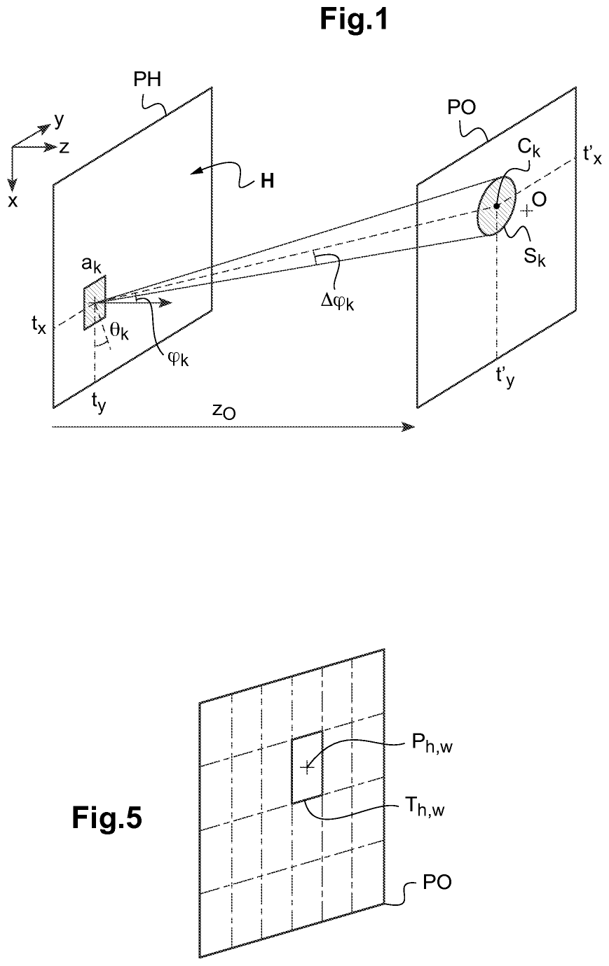

As proposed in article “Color digital hologram compression based on matching pursuit” by A. El Rhammad, P. Gioia, A. Gilles, M. Cagnazzo and B. Pesquet-Popescu, in Applied Optics, Vol. 57, n° 17, Jun. 10, 2018, each atom aₖ of the set A_{K} can be in practice defined by:
the position of the atom aₖ in the plane PH of the digital hologram H, by means here of the coordinates (tₓ, t_{y}) of the atom aₖ (where tₓ and t_{y} are the first 2 coordinates in a reference system (x, y, z) represented in FIG. 1, with z=0 in the plane PH of the digital hologram);
an index of dilation lₖ;
an index of rotation pₖ;
a (complex) coefficient cₖ.

In this definition, the index of dilation lₖ is an integer whose value is between 1 and a predetermined number S; likewise, the index of rotation pₖ is an integer whose value is between 1 and a predetermined number P.

The index of dilation lₖ and the index of rotation pₖ define a discrete Gabor wavelet g_{lk, pk} (as described in more detail in the above-mentioned article) and the coefficient cₖ then corresponds to the scalar product of the digital hologram H and this Gabor wavelet g_{lk, pk} taken at the point of coordinates (tₓ, t_{y}) in the plane PH of the digital hologram H.

Each atom aₖ (defined as indicated hereinabove) hence corresponds to a light ray diffracted at the point of coordinates (tₓ, t_{y}) of the digital hologram H with a direction defined by an azimuth angle θₖ and a diffraction angle φₖ and an angular dispersion Δφₖ, as shown in FIG. 1.

These angles θₖ, φₖ and angular dispersion Δφₖ are defined for each atom aₖ (due to the Gabor wavelet associated with this atom aₖ), here from the parameters defining the involved atom aₖ as indicated hereinabove:

θₖ=(pₖ−1).π/P;

φₖ=arcsin(λ.f/s(lₖ));

Δφₖ=arcsin(λ.(f+αₖ))−arcsin(λ.f),

where λ is the wavelength of the involved light, s(lₖ) the parameter of dilation associated (in a manner defined in the chosen representation) with the index of dilation lₖ, αₖ the frequency width of the Gaussian window, which depends on the parameter of dilation s(lₖ), and f the spatial frequency of the Gabor mother wavelet (from which the Gabor wavelet associated with the atom aₖ is constructed, notably by dilation by the above-mentioned parameter of dilation; we generally take f=(2Δ)⁻¹ where Δ is the spacing between 2 pixels of the digital hologram H).

It should be noted in this respect that the operation is described here for a particular chromatic component (of wavelength λ) of the digital hologram H. However, the digital hologram H could in practice include other chromatic components, each of the chromatic components being then processed and transmitted as will described hereinafter.

Moreover, as indicated hereinabove, the embodiment described here uses a decomposition using Gabor wavelets. However, as an alternative, other decompositions could also be used, for example using Morlet wavelets, as described for example in article “Morlet Wavelet transformed holograms for numerical adaptive view-based reconstruction”, by K. Viswanathan, P. Gioia and L. Morin, in Proc. SPIE 9216, Optics and Photonics for Information Processing VIII, August 2014, San Diego, United-States.

Moreover, in the example described herein, the set Aₖ of atoms aₖ representing the digital hologram H is obtained by selecting the atoms aₖ among a wider set A_{N} of atoms aₙ, here by means of a “Matching Pursuit” algorithm as described in the precited article and mentioned hereinafter. (The wider set A_{N} is for example the set of the N atoms aₙ associated with all the Gabor wavelets conceivable for the Nₓ.N_{y} points of the digital hologram, respectively, for the S discretized indices of dilation and the P discretized indices of rotation, i.e. N=Nₓ.N_{y}.S.P).

Such a selection allows obtaining a parsimonious representation of the digital hologram H by the atoms aₖ of the set Aₖ.

The invention is however not limited to the case of a set Aₖ ensuing from such a selection and could therefore be applied, for example, to the set A_{N} mentioned hereinabove.

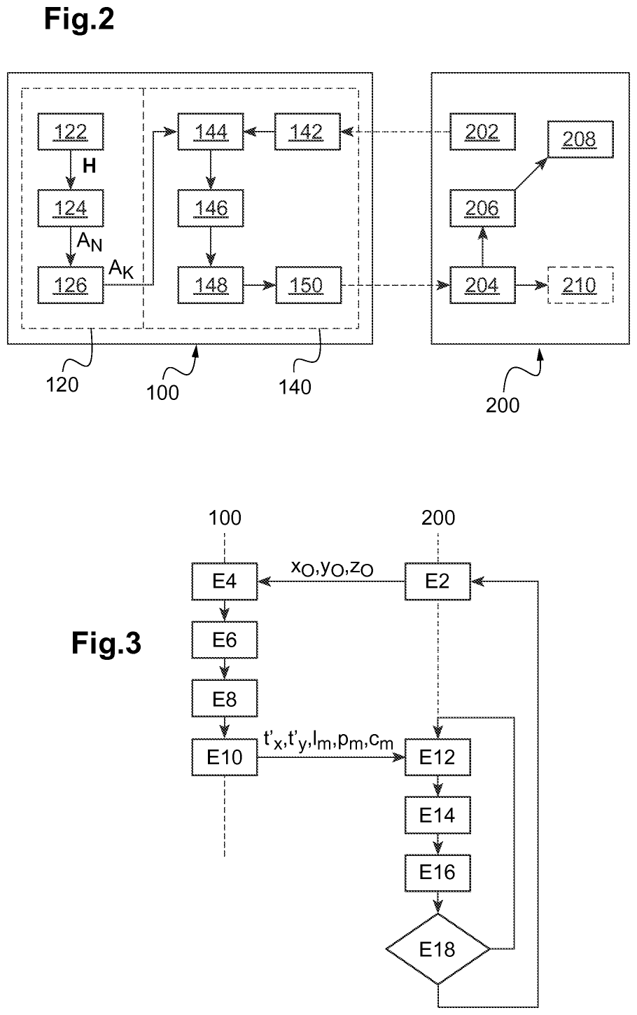

FIG. 2 shows a data exchange system according to a first embodiment of the invention.

This system includes a first electronic device 100 (here a server) and a second electronic device 200 (here a client device such as a personal computer or a multifunction mobile).

The electronic device 100 includes a unit 120 for the construction of a representation of the digital hologram H and a unit 140 for the preparation and sending of a flow of data.

As will be apparent from the following description, the construction unit 120 includes several modules intended to operate offline, i.e. before the exchange of data with the second electronic device 200. The preparation and sending unit 140 itself includes several modules intended to operate online, i.e. during the exchange of data with the second electronic device 200.

The electronic device 100 includes (here within the above-mentioned construction unit 120) a digital hologram generation module 122, an expansion module 124 and a reduction module 126.

The digital hologram generation module 122 is designed to calculate the digital hologram H from descriptive data of different views and depth of a three-dimensional scene, as described for example in article “Computer generated hologram from multiview-plus-depth data considering specular reflections” by A. Gilles et al., in 2016 IEEE International Conference on Multimedia & Expo Workshops (ICMEW), IEEE 2016.

As an alternative, the digital hologram H could be determined by acquisition of a real scene using image sensors.

As already indicated, the digital hologram H has a resolution (Nₓ, N_{y}) and can hence be defined by a matrix of dimensions Nₓ×N_{y} with complex coefficients.

The expansion module 124 is designed to produce a first representation A_{N} of the digital hologram H, here by means of N Gabor atoms aₙ.

As indicated hereinabove, this first representation A_{N} is obtained by projecting (in practice by means of a scalar product operation) the digital hologram H on a set of Gabor wavelets g (by considering, for each point of the digital hologram H, the different Gabor wavelets g each having a parameter of dilation chosen among S predefined parameters of dilation and a parameter of orientation chosen among P predefined parameters of orientation).

Each atom aₙ of the set A_{N} is hence defined by:
the coordinates (tₓ, t_{y}) of the point of the digital hologram H that is associated with this atom aₙ;
an index of dilation lₙ and an index of rotation pₙ defining the parameter of dilation (of spatial frequency) s(lₙ) and the parameter of orientation θ(pₙ) of the involved Gabor wavelet g_{ln, pn}, respectively;
the coefficient cₙ obtained by projection (i.e. by scalar product) of the digital hologram H on this Gabor wavelet d_{ln, pn}.

The reduction module 126 is designed to obtain, based on the first representation A_{N} of the digital hologram H, a second representation A_{K} of the digital hologram H, here by selection (among the atoms aₙ described hereinabove) of the most relevant atoms aₖ for the reconstruction by means of a “Matching Pursuit” algorithm, as described in the above-mentioned article “Color digital hologram compression based on matching pursuit”.

Each atom aₖ of the set A_{K} is hence an atom of the set A_{N} and can thus be defined by:
the coordinates (tₓ, t_{y}) of the point of the digital hologram H that is associated with this atom aₖ;
an index of dilation lₖ and an index of rotation pₖ;
a coefficient cₖ.

The electronic device 100 moreover includes (here within the above-mentioned preparation and sending unit 140) a reception module 142, a selection module 144, an ordering module 146, an encoding module 148 and a transmission module 150.

The reception module 142 is in particular designed to receive data defining the position of an observer O that wants to view the digital hologram H. This position is for example defined by coordinates (x_{O}, y_{O}, z_{O}) in the above-mentioned reference system, linked to the digital hologram H (the plane PH of the digital hologram H corresponding, as already indicated, to the plane of equation z=0).

The data received by the reception module 142 (here the first 2 coordinates x_{O}, y_{O}) are hence representative in particular of the position of observation (position of the observer O) in the plane of observation PO (plane parallel to the plane PH of the digital hologram H and passing through the position of the observer O, hence of equation z=z_{O}).

It is herein described a solution in which data representative of the digital hologram H are transmitted for a single observer O. It could however be provided, in practice, to receive the respective positions of several observers, then to prepare and send data for each of these observers (by using the solution proposed hereinafter separately for each of these observers and gathering the data relating to the different observers in a same flow of data).

It is possible to define, based on the position of the observer O, a viewing window V located in the plane of observation PO and containing the position of the observer O (by being for example centered on the position of the observer O). The (predefined) resolution of the viewing window V is denoted (Vₓ, V_{y}).

As well seen in FIG. 1, it is moreover defined, for each atom aₖ, a diffraction spectrum Sₖ of this atom aₖ in the plane of observation PO: this diffraction spectrum S_{K} is the intersection of the plane of observation PO and of the light ray associated with the atom aₖ as explained hereinabove (and visible in FIG. 1).

The position (t′ₓ, t′_{y}) of the center Cₖ of the diffraction spectrum Sₖ (in the plane of observation PO) can hence be obtained based on the coordinates (tₓ, t_{y}) of the involved atom aₖ, on the azimuth angle θₖ and the diffraction angle φₖ associated with the involved atom aₖ (as explained hereinabove) and on the ordinate z_{O} of the plane of observation PO. Precisely, we have:

t′ₓ=tₓ−z_{O}.tan φₖ.sin θₖ and t′_{y}=t_{y}+z_{O}.tan φₖ. cos θₖ.

The selection module 144 is designed to select, among the atoms aₖ of the set Aₖ, the atoms aₘ whose diffraction spectrum Sₘ in the plane of observation PO has an intersection with the viewing window V. (It is to be noted, within this framework, that the radius of the diffraction spectrum Sₖ is equal to z_{O}.tan(Δφₖ).)

We denote A_{M} the set of the M atoms aₘ so selected by the selection module 144:

A_{M}={aₖ € A_{K}|Sₖ ∩ V≠Ø}.

As an alternative, the selection module 144 could select among the atoms aₖ of the set A_{K}, the atoms aₘ for which the center Cₘ of the diffraction spectrum Sₘ is located in the viewing window V.

The ordering module 146 is designed to determine an order of transmission within the atoms aₘ of the set A_{M}, taking into account in particular the distance between the position of observation (position of the observer O) and the center Cₘ of the diffraction spectrum Sₘ associated with each of these atoms aₘ, but also here (subsidiarily) the amplitude |cₘ| of the coefficient cₘ of each of these atoms aₘ and/or the angular dispersion Δφₘ associated with each of these atoms aₘ, as described hereinafter.

For that purpose, the ordering module 146 calculates, for each atom aₘ, the distance OCₘ between the position of observation and the center Cₘ of the diffraction spectrum Sₘ associated with this atom aₘ.

The ordering module 146 can then rank the atoms aₘ as a function of the associated distance OCₘ, for example in increasing order of the associated distance OCₘ (it can then be talked about “spiral scan” of the atoms aₘ).

This amounts to saying that the ordering module 146 determines in this case a function f:[1; M]→[1; M] defining the obtained ordering and such that:

OC_{f(i-1)}≤OC_{f(i)} for any integer i between 2 and M.

The atoms of the set A_{M} are then ordered as follows: a_{f(1)}, a_{f(2)}, . . . a_{f(M)} as a function of the distance (in the plane of observation PO) between the position of observation O and the center Cₘ of the diffraction spectrum Sₘ associated with the involved atom aₘ (precisely in increasing associated distance OCₘ).

It is here moreover proposed to refine as follows this ordering for atoms aₘ having relatively close distances OCₘ.

For two atoms aᵢ and aⱼ for which |OCᵢ−OCⱼ|<ϵ (with ϵ a predefined value, preferably low, typically ϵ<0.1.Vₓ and ϵ<0.1.V_{y}):
if Δφᵢ=Δφⱼ, the atom (aᵢ or aⱼ) having the coefficient (|cᵢ| or |cⱼ|) of highest amplitude is placed first;
if Δφᵢ≠Δφⱼ and ||cᵢ|−|cⱼ||<T, with T a predefined threshold, the atom (aᵢ or aⱼ) having the highest angular dispersion (Δφᵢ or Δφⱼ) is placed first;
if Δφᵢ≠Δφⱼ and ||cᵢ|−|cⱼ||≥T, the atom (aᵢ or aⱼ) having the coefficient (|cᵢ| or |cⱼ|) of highest amplitude is placed first.

In this case, the above-mentioned function f defining the ordering is such that, for any integer i between 2 and M:

OC_{f(i-1)}≤OC_{f(i)} if |OC_{f(i-1)}−OC_{f(i)}|≥ϵ;
   |C_{f(i-1)}|>|C_{f(i)}| if |OC_{f(i-1)}−OC_{f(i)}|<ϵ and Δφ_{f(i-1)}=Δφ_{f(i)};

Δφ_{f(i-1)}>Δφ_{f(i)} if |OC_{f(i-1)}−OC_{f(i)}|<ϵ and Δφ_{f(i-1)}≠Δφ_{f(i)} and ||C_{f(i-1)}|−|C_{f(i)}||<T;

|C_{f(i-1)}|>|C_{f(i)}| if |OC_{f(i-1)}−OC_{f(i)}|<ϵ and Δφ_{f(i-1)}≠Δφ_{f(i)} and ||C_{f(i-1)}|−|C_{f(i)}||24 T.

The atoms of the set A_{M} are then ordered as follows: a_{f(1)}, a_{f(2)}, . . . a_{f(M)} as a function of the distance (in the plane of observation PO) between the position of observation O and the center Cₘ of the diffraction spectrum Sₘ associated with the involved atom aₘ, of the angular dispersion Δφₘ associated with the involved atom aₘ and of the amplitude |cₘ| of the involved atom aₘ.

The encoding module 148 is designed to encode the parameters defining each of the atoms aₘ of the set A_{M}, in the order defined by the ordering module 146, into a flow of data to be transmitted.

In order to limit the quantity of data to be transmitted, it is herein proposed to encode the position of each atom aₘ by means of data representative of the position of the center Cₘ of the diffraction spectrum Sₘ of this atom aₘ in the viewing window V. (The quantity of data required for the encoding of this position in the viewing window is linked to the resolution Vₓ, V_{y} of this window and can be estimated by log₂(Vₓ)+log₂(V_{y}), i.e. less than the required quantity for encoding the position in the plane PH of the digital hologram H, of the order of log₂(Nₓ)+log₂(N_{y}).

Indeed, as already indicated and visible in FIG. 1, the coordinates (t′ₓ, t′_{y}) of the center Cₘ of the diffraction spectrum Sₘ of an atom aₘ are linked to the coordinates (tₓ, t_{y}) of the position of this atom aₘ in the plane PH of the digital hologram H by means of the azimuth angle θₘ, the diffraction angle φₘ associated with this involved atom aₘ and the ordinate z_{O} of the plane of observation (PO).

In the case of the above-mentioned spiral scan, a differential encoding of the positions of the centers Cₘ of the diffraction spectra Sₘ of the successively encoded atoms aₘ can further be used. For example, the positions in the viewing window V being discretized, a spiral path can be defined (within the viewing window V), starting from the position of observation O; the respective positions of the centers Cₘ of the diffraction spectra Sₘ of the atoms aₘ can then be encoded by means of the distance separating, on the spiral path, the involved center Cₘ from the preceding center Cₘ.

The other parameters defining the atoms aₘ (index of dilation lₘ, index of rotation pₘ, coefficient cₘ) can themselves be encoded as described in the above-mentioned article “Color digital hologram compression based on matching pursuit”:
the index of dilation lₘ is encoded by means of a context-free arithmetic encoder;
the index of rotation pₘ is encoded over a predetermined number of bits (equal to log₂ P);
the real part and the imaginary part of the coefficients cₘ are respectively quantified then encoded by means of a contextual arithmetic encoder.

The transmission module 150 is designed to transmit the flow of data prepared by the encoding module 148 on a communication network towards the second electronic device 200.

These data are transmitted in the order determined by the ordering module 146 (order followed by the encoding module 148 as indicated hereinabove) so that the descriptive data of the different atoms aₘ are transmitted in the order allocated to these atoms aₘ by the ordering module 146.

The above-mentioned modules 122, 124, 126, 142, 144, 146, 148, 150 can in practice be implemented by the cooperation of at least one hardware element (such as a processor of the first electronic device 100 and/or, in particular for the reception module 142 and/or the transmission module 150, a communication circuit) and software elements (such as computer program instructions executable by the above-mentioned processor).

These computer program instructions can in particular be such that the first electronic device 100 implements a part at least of the steps described hereinafter with reference to FIG. 3 when these instructions are executed by the processor of the first electronic device 100.

The second electronic device 200 includes a transmission module 202, a receiving module 204, a reconstruction module 206, a display 208 and a storage module 210.

The transmission module 202 is designed to transmit (towards the first electronic device 100, and precisely the above-mentioned reception module 142) the above-mentioned data defining the position of an observer O, here defined by coordinates (x_{O}, y_{O}, z_{O}) in the reference system linked to the digital hologram H. (This position corresponds for example to a virtual position of the wearer of the second electronic device 200 with respect to the digital hologram H).

The transmission module 202 can in practice transmit these data on the above-mentioned communication network (used by the transmission module 150 of the first electronic device 100). However, as an alternative, the transmission module 202 could transmit these data on another communication network (but always towards the reception module 142 of the first electronic device 100, this reception module 142 being in this case connected to this other communication network).

The receiving module 204 is designed to receive the descriptive data of the different atoms aₘ from the transmission module 150 of the first electronic device 100 and to decode these data.

The receiving module 204 hence receives the descriptive data of different atoms aₘ in the order determined by the ordering module 146, these data here representing (after decoding), for each atom aₘ:
the coordinates (t′ₓ, t′_{y}) of the center Cₘ of the diffraction spectrum Sₘ of the atom aₘ (coordinates within the viewing window V);
the index of dilation lₘ, the index of rotation pₘ and the coefficient cₘ defining the atom aₘ.

The reconstruction module 206 is designed to calculate a sub-digital hologram H′ by means of the atoms aₘ for which the descriptive data have been received.

For that purpose, for each atom aₘ whose descriptive data are received, the reconstruction module 206 determines the position (tₓ, t_{y}) of the involved atom aₘ as a function of the coordinates (t′x, t′_{y}) of the center Cₘ of the diffraction spectrum Sₘ of this atom aₘ, of the azimuth angle θₘ and of the diffraction angle φₘ associated with this atom aₘ and of the ordinate z_{O} of the position of the observer O. (It is recalled that the azimuth angle θₘ and the diffraction angle φₘ can be calculated as a function of the index of dilation lₘ and the index of rotation pₘ, as indicated hereinabove).

The reconstruction module 206 can then calculate the sub-digital hologram H′ by summing the contribution of the different atoms aₘ for which the descriptive data have been received:

H′=Σ_{(am received)} cₘ, g_{lm, pm}(tₓ, t_{y}).

The display 208 (using for example a spatial light modulator, or SLM, and potentially integrated into a head-mounted display, for example an augmented reality head-mounted display) can then display the sub-digital hologram H′ reconstructed as indicated hereinabove by the reconstruction module 206.

The storage module 210 stores the atom descriptive data received for all or part of the atoms aₘ (in order to avoid a new transmission of the data relating to these atoms when some of them are used for constructing a new sub-hologram after the observer O has moved). The use of such a storage module 210 is optional. In this case, the second electronic device 200 can indicate (by transmission of suitable information) to the first electronic device 100 the atoms for which the descriptive data are stored in the storage module 210, so that the first electronic device 100 does not retransmit these data latter.

According to another possibility, this is the first electronic device 100 that stores a history indicating, for each atom aₖ participating to the representation of the digital hologram H, if the descriptive data of this atom aₖ have been transmitted to the second electronic device 200. The encoding module 148 can also consult this history and not include in the flow of data to be transmitted data relating to the atoms aₖ mentioned in this history as already transmitted.

The above-mentioned modules 202, 204, 206, 208, 210 can in practice be implemented by the cooperation of at least one hardware element (such as a processor of the second electronic device 200 and/or, in particular for the receiving module 204 and/or the transmission module 202, a communication circuit) and software elements (such as computer program instructions executable by the above-mentioned processor).

These computer program instructions can in particular be such that the second electronic device 200 implements a part at least of the steps described hereinafter with reference to FIG. 3, when these instructions are executed by the processor of the second electronic device 200.

FIG. 3 shows the main steps of an exemplary data transmission method in accordance with the first embodiment.

This method begins at step E2, at which the transmission module 202 of the second electronic device 200 transmits to the reception module 142 of the first electronic device 100 the coordinates (x₀, y₀, z₀) representative of the position of the observer O. In particular, the coordinates (x_{O}, y_{O}) are hence representative of a position of observation in the plane of observation PO (parallel to the plane PH of the digital hologram H), plane of observation PO defined by the equation z=z_{O}.

The reception module 142 of the first electronic device 100 receives the coordinates (x₀, y₀, z₀) representative of the position of the observer O at step E4.

The selection module 144 then selects (step E6), among the atoms aₖ of the set A_{K} representing the digital hologram H, the atoms aₘ whose diffraction spectrum Sₘ in the plane of observation PO has an intersection with the viewing window V (or, as an alternative, the atoms aₘ for which the center Cₘ of the diffraction spectrum Sₘ is located in the viewing window V).

It is recalled that the viewing window V contains the position of the observer O (by being for example centered on the position of the observer O) and has a predefined resolution (Vₓ, V_{y}). The viewing window V therefore depends on the coordinates (x₀, y₀) received at step E4.

The ordering module 146 can then determine, at step E8, an order for the atoms aₘ selected at step E6, as a function of the distance, in the plane of observation (PO), between the position of observation (defined by the coordinates (x₀, y₀)) and the center Cₘ of the diffraction spectrum Sₘ of each of these atoms aₘ, as explained in more detail hereinabove.

As also indicated hereinabove, the above-mentioned order can also be determined as a function of the angular dispersion Δφₘ and/or of the amplitude of the coefficient |cₘ| associated with each of these atoms aₘ.

The encoding module 148 proceeds, for each of the atoms aₘ selected at step E6 and in the order determined at step E8, to the encoding of the descriptive data of the involved atom am (step E10), i.e. here, as explained hereinabove:
the coordinates (t′ₓ, t′_{y}) of the center Cₘ of the diffraction spectrum Sₘ of the involved atom aₘ (coordinates within the viewing window V);
the index of dilation lₘ, the index of rotation pₘ and the coefficient cₘ defining the atom aₘ.

For these atoms aₘ whose descriptive data are encoded, and hence in the order determined at step E8, the encoded descriptive data are further transmitted at step E10 by the transmission module 150 of the first electronic device 100 towards the receiving module 204 of the second electronic device 200, via the communication network.

These descriptive data of atoms aₘ are hence received by the receiving module 204 and are decoded (step E12).

The reconstruction module 206 can then calculate, at step E14, the sub-digital hologram H′ by means of the descriptive data of the atoms aₘ received at this precise time.

This step E14 comprises in particular the following sub-steps at receipt of the descriptive data of an atom aₘ:
calculating the coordinates (tₓ, t_{y}) of the position of this atom aₘ as a function of the coordinates (t′ₓ, t′_{y}) of the center Cₘ of the diffraction spectrum Sₘ received for this atom aₘ, of the index of dilation lₘ received for this atom aₘ and of the index of rotation pₘ received for this atom aₘ (by means of the azimuth angle θₘ and the diffraction angle φₘ associated with this atom aₘ);
adding the contribution of this atom aₘ to the sub-digital hologram H′, this contribution being obtained by application of the coefficient cₘ received for this atom aₘ on the Gabor wavelet g_{lm, pm} associated with the index of dilation lₘ and the index of rotation pₘ and taken at the point of coordinates (tₓ, tᵥ).

The current sub-digital hologram H′ can hence be displayed by means of the display 208 at step E16.

It is then determined, at step E18 (for example by the processor of the second electronic device 200), if the position of the observer O has changed.

In case of negative result (i.e., if the position of the observer O is unchanged), the method continues at step E12 for potentially receiving descriptive data of other atoms aₘ (then adding their contribution at step E14 and displaying the completed sub-digital hologram H′ at step E16).

A progressive transmission and display of the sub-digital hologram H′ is hence obtained.

In case of positive result at step E18 (i.e. if the position of the observer O has changed), the method continues at step E2 for transmitting the coordinates of the new position of the observer O. In this case, the reiteration of steps E6, E8 and E10 will allow an adaptation of the viewing window V, of the order of the atoms aₘ and hence of the data transmitted to the new position of the observer O.

It can be provided as an alternative that the coordinates (x₀, y₀, z₀) are periodically transmitted from the transmission module 202 of the second electronic device 200 to the reception module 142 of the first electronic device 100 (without waiting for a potential change of position of the observer O). In this case, the first electronic device 100 is for example designed not to reiterate steps E6 and E8 as long as the position of the observer O is unchanged.

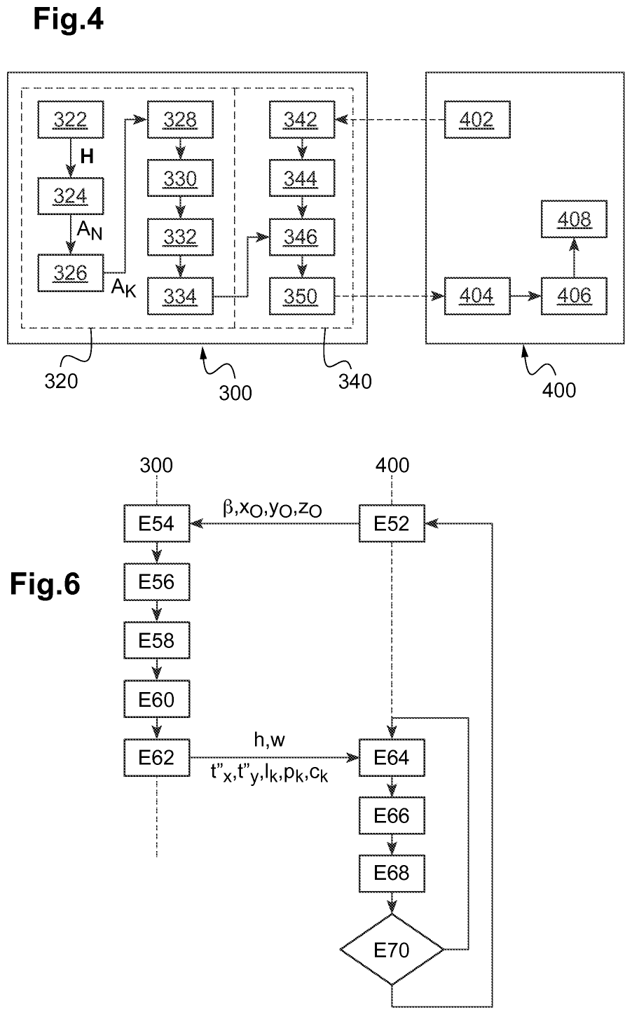

FIG. 4 shows a data exchange system according to a second embodiment of the invention.

This system includes a first electronic device 300 (here a server) and a second electronic device 400 (here a client device such as a personal computer or a multifunction mobile).

The electronic device 300 includes a unit 320 for the construction of data packets and a unit 340 for the preparation and sending of a flow of data.

As will become apparent from the following description, the construction unit 320 includes several modules intended to operate offline, i.e. before the exchange of data with the second electronic device 400. The preparation and sending unit 340 itself includes several modules intended to operate online, i.e. during the exchange of data with the second electronic device 400.

The electronic device 300 includes (herein within the above-mentioned construction unit 320) a digital hologram generation module 322, an expansion module 324, a reduction module 326, an association module 328, an ordering module 330, an encoding module 332 and a data packet generation module 334.

The modules 322, 324, 326 are identical to the modules 122, 124, 126 described hereinabove with reference to FIG. 2 and reference can hence be made to the description of the modules 122, 124, 126 for more explanation on that subject.

The digital hologram generation module 322 is designed to calculate the digital hologram H, based on data simulating a scene or by acquisition of a real scene by means of image sensors.

The expansion module 324 is designed to produce a first representation A_{N} of the digital hologram H, here by means of N Gabor atoms aₙ.

Each atom aₙ of the set A_{N} is defined by:
the coordinates (tₓ, t_{y}) of the point of the digital hologram H associated with this atom aₙ;
an index of dilation lₙ and an index of rotation pₙ defining the parameter of dilation s(lₙ) and the parameter of orientation θ(pₙ) of the involved Gabor wavelet g_{ln, pn}, respectively;
the coefficient cₙ obtained by projection (i.e. by scalar product) of the digital hologram H on this Gabor wavelet g_{ln, pn}.

The reduction module 326 is designed to obtain, based on the first representation A_{N} of the digital hologram H, a second representation A_{K} of the digital hologram H, here by selection (among the above-described atoms aₙ) of the most relevant atoms aₖ for the reconstruction by means of a “Matching Pursuit” algorithm, as described in the above-mentioned article “Color digital hologram compression based on matching pursuit”.

Each atom aₖ of the set A_{K} is hence an atom of the set A_{N} and can hence be defined by:
the coordinates (tₓ, t_{y}) of the point of the digital hologram H associated with this atom aₖ;
an index of dilation lₖ and an index of rotation pₖ;
a coefficient cₖ.

In the present embodiment, as shown in FIG. 5, the plane of observation PO (plane including the observer O and parallel to the plane PH of the digital hologram H) is divided into predefined regions, here blocks (or tiles) T_{h,w}. For a plane of observation PO, the different blocks T_{h,w} cover the whole part of the plane PO that is accessible by the observer O (here, without overlap between the different blocks T_{h,w}). In the following, the center of a block T_{h,w} is denoted P_{h,w}, and the resolution of the blocks T_{h,w} is denoted (Mₓ, M_{y}) (the indices h and w representing the position of the involved block T_{h,w} in height and width, respectively in the plane of observation PO).

The association module 328 is designed to associate, for a given plane of observation PO, each of the atoms aₖ of the set A_{K} with a block T_{h,w}, precisely the block T_{h,w} containing the center Cₖ of the diffraction spectrum Sₖ of the involved atom aₖ.

As already indicated in relation with the first embodiment, the position of the center Cₖ of the diffraction spectrum Sₖ can be obtained based on the coordinates (tₓ, t_{y}) of the involved atom aₖ, the azimuth angle θₖ and the diffraction angle φₖ associated with the involved atom aₖ (as explained hereinabove) and on the distance separating the plane of observation PO and the plane PH of the digital hologram H.

The just-described distribution of the atoms aₖ among the blocks T_{h,w} (by means of the association module 328) can be made in practice for a plurality of planes of observation PO in such a way as to cover the space accessible by the observer O.

The ordering module 330 is designed to order, for each block T_{h,w}, the different atoms aₖ associated with this block T_{h,w}, for example as a function of the angular dispersion Δφₖ and/or the amplitude |cₖ| of the coefficient cₖ respectively associated with these atoms aₖ.

The ordering module 330 can for example, in practice, order, for a given block T_{h,w}, the atoms aₖ associated with this block T_{h,w} in decreasing associated values of angular dispersion Δφₖ and, for atoms aₖ of same angular dispersion Δφₖ, in decreasing associated values of amplitude |cₖ|.

The encoding module 332 is designed to encode, for each block T_{h,w}:
data representative of the position of the block T_{h,w} in the plane of observation (for example, here, due to a predefined cutting, the indices h and w of the block T_{h,w} give the location thereof and can hence be used to represent the position of this block T_{h,w}).

The encoding module 332 is also designed to encode, for all the atoms of each block T_{h,w}, the descriptive data of the involved atom aₖ:
coordinates (t″ₓ, t″_{y}) defining the position of the center Cₖ of the diffraction spectrum Sₖ of the involved atom aₖ within the block T_{h,w} with which is associated this atom aₖ;
the index of dilation lₖ, the index of rotation pₖ and the coefficient cₖ defining the involved atom aₖ.

The encoding of the position of the center Cₖ of the diffraction spectrum is particularly inexpensive in this case (of the order of log₂(Mₓ)+log₂(M_{y})).

For each atom aₖ, the coefficient cₖ can in practice be encoded on several planes of bits (in such a way as to be able to adapt the quantity of data to be transmitted to the rate available on the communication network, as explained hereinafter). It can be provided, for example, an encoding of the coefficients cₖ using a lower number of bits if these coefficients belong to blocks T_{h,w} remote from the position of observation O, by adaptatively reducing for example the number of planes of bits as a function of the distance OP_{h,w}.

Reference can moreover be made on that subject to the explanations given within the framework of the first embodiment and in the above-mentioned article “Color digital hologram compression based on matching pursuit”.

The data packet generation module 334 is designed to construct, for each block T_{h,w}, an associated packet of data B_{h,w}.

In this data packet B_{h,w}, the descriptive data of the atoms aₖ, encoded by the encoding module 332, are placed in accordance with the order determined by the ordering module 330.

When several planes of bits are used for the encoding of the coefficients cₖ, the generation module 334 constructs the packet of data B_{h,w} by placing:
firstly, the descriptive data of the atoms aₖ including only the first plane of bits for the coefficients cₖ (i.e. a part only of the bits representing the coefficients cₖ), in the order of the atoms aₖ determined by the ordering module 330,
then, the second plane of bits for the coefficients cₖ, also in the order of the atoms determined by the ordering module 330,
then, if such a plane of bits exists, the third plane of bits for the coefficients cₖ, still in the order of the atoms aₖ determined by the ordering module 330, etc.

It is provided, in this case, that the planes are defined in a decreasing order of significance of the involved bits: the first plane of bits corresponding to the most significant bits, the second plane of bits corresponding to less significant bits, and the third plane of bits (in the above-mentioned example) to still less significant bits.

It is observed that, just as the module 328, the modules 330, 332, 334 can perform the above-mentioned processing operations for a plurality of planes of observation PO in such a way as to cover the space accessible by the observer O.

The electronic device 300 moreover includes (here within the above-mentioned preparation and sending unit 340) a receiving module 342, a calculation module 344, a selection module 346 and a transmission module 350.

The receiving module 342 is designed to receive data defining the position of an observer O that wants to view the digital hologram H and here also data β indicative of the bandwidth available on the communication network.

As in the first embodiment, the position of the observer O is for example defined by coordinates (x_{O}, y_{O}, z_{O}) in a reference system linked to the digital hologram H (the plane PH of the dispositive corresponding to the plane of equation z=0).

Here, a solution is described in which the data representative of the digital hologram H are transmitted for a single observer O. As for the first embodiment, it could however be provided in practice to receive the respective positions of several observers, then to prepare and send data for each of these observers (by using the solution proposed hereinafter separately for each of these observers and by gathering the data relating to the different observers in a same flow of data).

The calculation module 344 is designed to calculate, for a part at least of the blocks T_{h,w}, the distance OP_{h,w} between the position of the observer O and the center P_{h,w} of the involved block T_{h,w} in the plane of observation PO. (It is recalled that the blocks T_{h,w} form a predefined division, or partition, of the accessible part of the plane of observation PO and the coordinates of the centers P_{h,w} of these blocks T_{h,w} are hence predefined in the plane of observation PO.)

The selection module 346 is designed to assemble data coming from the different packets B_{h,w} (prepared by the generation module 334), according to an order determined as a function of the distance OP_{h,w} associated with the different blocks T_{h,w}, respectively, in order to construct the flow of data to be transmitted. The quantity of data used in each packet B_{h,w} can depend in practice on the available bandwidth (indicated by the data β received by the receiving module 342), each packet B_{h,w} being able to be truncated in such a way as to include, for example, in the flow of data to be transmitted, only a part of the planes of bits representing the coefficients cₖ.

It is observed that the packets B_{h,w} that are used are those which have been produced by the generation module 334 for the plane of observation PO that is the closest to the position of the observer O (as received by the receiving module 342).

In practice, the selection module 346 ranks the blocks T_{h,w} in increasing order of the distance OP_{h,w} associated with each of these blocks T_{h,w}, and, by going through the blocks T_{h,w} in this order, places in the flow of data a part at least of the packet B_{h,w} associated with the current block T_{h,w} (this part can depend on the available bandwidth β as indicated hereinabove).

The transmission module 350 is designed to transmit the flow of data so prepared by the selection module 346 towards the second electronic device 400. The data are hence transmitted in the order determined by the selection module 346 as explained hereinabove.

The above-mentioned modules 322, 324, 326, 328, 330, 332, 334, 342, 344, 346, 348, 350 can in practice be implemented by the cooperation of at least of one hardware element (such as a processor of the first electronic device 300 and/or, in particular for the receiving module 342 and/or the transmission module 350, a communication circuit) and of software elements (such as computer program instructions executable by the above-mentioned processor).

These computer program instructions can in particular be such that the first electronic device 300 implements a part at least of the steps described hereinafter with reference to FIG. 6 when these instructions are executed by the processor of the first electronic device 300.

The second electronic device 400 includes a transmission module 402, a reception module 404, a reconstruction module 406 and a display 408.

The transmission module 402 is designed to transmit (towards the first electronic device 300 and, precisely the above-mentioned receiving module 342) the above-mentioned data β (indicative of the bandwidth available on the communication network) and the above-mentioned data defining the position of an observer O, here defined by coordinates (x_{O}, y_{O}, z_{O}) in the reference system linked to the digital hologram H. (This position corresponds for example to a virtual position of the wearer of the second electronic device 400 with respect to the digital hologram H).

The transmission module 402 can transmit in practice these data on the above-mentioned communication network (used by the transmission module 350 of the first electronic device 300). However, as an alternative, the transmission module 402 could transmit these data on another communication network (but still towards the receiving module 342 of the first electronic device 300, this receiving module 342 being in this case connected to this other communication network).

The reception module 404 is designed to receive the descriptive data of the different atoms aₘ (relating to different blocks T_{h,w} successively) from the transmission module 350 of the first electronic device 300 and to decode these data.

The reception module 404 hence receives the descriptive data of different atoms aₖ associated with certain blocks T_{h,w} in the order determined for these blocks T_{h,w} by the selection module 346. These data represent (after decoding) for each block T_{h,w}:
the data representative of the position of the block T_{h,w} in the plane of observation PO (for example, here, the indices h and w of the block T_{h,w}),

then, for the atoms aₖ of this block:
the coordinates (t″ₓ, t″_{y}) defining the position of the center Cₖ of the diffraction spectrum Sₖ of the involved atom aₖ within the block T_{h,w};
the index of dilation lₖ, the index of rotation pₖ and certain bits at least of the coefficient cₖ defining the involved atom aₖ.

The reconstruction module 406 is designed to calculate a sub-digital hologram H′ by means of the atoms aₖ for which the descriptive data have been received.

For that purpose, for each atom aₖ whose descriptive data are received, the reconstruction module 406 determines the position (tₓ, t_{y}) of the involved atom aₖ as a function of the coordinates (t″ₓ, t″_{y}) of the center Cₘ of the diffraction spectrum Sₘ of this atom aₖ within the block T_{h,w}, of the position of the involved block T_{h,w}, of the azimuth angle θₖ and the diffraction angle φₖ associated with this atom aₖ and of the ordinate z_{O} of the position of the observer O (or of the plane of observation PO for which the packet of data B_{h,w} has been calculated as indicated hereinabove, these planes of observation being predefined). (It is recalled that the position of each block T_{h,w} is predefined and hence known when the block T_{h,w} is identified, here by the indices h and w, and that the azimuth angle θₖ and the diffraction angle φₖ can be calculated as a function of the index of dilation lₖ and the index of rotation pₖ, as indicated hereinabove).

The reconstruction module 406 can then calculate the sub-digital hologram H′ by summing the contribution of the different atoms aₘ for which the descriptive data have been received:

H′=Σ_{(ak received)} cₖ, g_{lk, pk}(tₓ, t_{y}).

The display 408 (using for example a spatial light modulator, or SLM, and potentially integrated into a head-mounted display, for example an augmented reality head-mounted display) can then display the sub-digital hologram H′ reconstructed as indicated hereinabove by the reconstruction module 406.

The above-mentioned modules 402, 404, 406, 408 can in practice be implemented by the cooperation of at least one hardware element (such as a processor of the second electronic device 400 and/or, in particular for the reception module 404 and/or the transmission module 402, a communication circuit) and software elements (such as computer program instructions executable by the above-mentioned processor).

These computer program instructions can in particular be such that the second electronic device 400 implements a part at least of the steps described hereinafter with reference to FIG. 6 when these instructions are executed by the processor of the second electronic device 400.

FIG. 6 shows the main steps of an exemplary data transmission method in accordance with the second embodiment.

This method starts at step E52 at which the transmission module 402 of the second electronic device 400 transmits, on the communication network and towards the receiving module 342 of the first electronic device 300, the data β indicative of the bandwidth available on the communication network and the data (x_{O}, y_{O}, z_{O}) representative of the position of the observer O.

The coordinates (x_{O}, y_{O}) are hence representative of a position of observation in the plane of observation PO (parallel to the plane PH of the digital hologram H).

The receiving module 342 of the first electronic device 300 receives that way the data β indicative of the bandwidth available on the communication network and the data (x_{O}, y_{O}, z_{O}) representative of the position of the observer O at step E54.

The calculation module 344 then calculates, at step E56, for a part at least of the blocks T_{h,w}, the distance OP_{h,w} between the position of the observer O and the center P_{h,w} of the involved block T_{h,w} in the plane of observation PO.

The selection module 346 can hence determine, at step E58, an order within these blocks T_{h,w} as a function of the distance OP_{h,w} previously calculated for each of these blocks T_{h,w}.

The selection module 346 then constructs, at step E60, the flow of data to be transmitted by assembling data from the different packets B_{h,w} (pre-calculated for the relevant plane of observation PO as explained hereinabove) in the order determined at step E58 for the blocks T_{h,w} associated with these packets B_{h,w}. As already explained, the quantity of data placed in the flow of data for a given packet B_{h,w} can be chosen in practice as a function of the available bandwidth indicated by the data β.

The transmission module 350 of the first electronic device 300 transmits at step E62 the flow of data constructed at step E60.

This flow of data hence contains, in the order of the blocks T_{h,w} determined at step E58 and for each block T_{h,w}:
the indices h, w of the involved block T_{h,w}, indicating the position of the involved block T_{h,w};
the descriptive data of the atoms aₖ included in the involved block, i.e. here for each atom aₖ of the involved block T_{h,w}: the coordinates (t″ₓ, t″_{y}) defining the position of the center Cₖ of the diffraction spectrum Sₖ of the atom aₖ within the block T_{h,w}, the index of dilation lₖ, the index of rotation pₖ and certain bits at least of the coefficient cₖ defining the involved atom aₖ.

The data are transmitted in encoded form, as explained hereinabove.

The reception module 404 of the second electronic device 400 receives and decodes this flow of data at step E64.

The reconstruction module 406 can then calculate, at step E66, a sub-digital hologram H′ by means of the descriptive data of the atoms aₖ received at this precise time.

This step E66 comprises in particular the following sub-steps at receipt of the descriptive data of an atom aₖ:
calculating the coordinates (tₓ, t_{y}) of the position of this atom aₘ as a function of the coordinates (t″ₖ, t″_{y}) of the center Cₖ of the diffraction spectrum Sₖ within the current block T_{h,w}, of the index of dilation lₖ and the index of rotation pₖ (through the azimuth angle θₖ and the diffraction angle φₖ that can be calculated as a function of the index of dilation lₖ and the index of rotation pₖ);
adding the contribution of this atom aₖ to the sub-digital hologram H′, this contribution being obtained by application of the part of the coefficient cₖ received for this atom aₖ on the Gabor wavelet g_{lk, pk} associated with the index of dilation lₖ and the index of rotation pₖ and taken at the point of coordinates (tₓ, t_{y}).

The current sub-digital hologram H′ can hence be displayed by means of the display 408 at step E68.

It is then determined, at step E70 (for example, by the processor of the second electronic device 400), if the position of the observer O has changed.

In case of negative result (i.e. if the position of the observer O is unchanged), the method continues at step E64 for continuing the reception of the flow of data and hence decoding data relating to the following blocks T_{h,w} and thus to the atoms aₖ contained in these blocks T_{h,w}. The respective contributions of these atoms aₖ are added at step E66 and the supplemented sub-digital hologram H′ is displayed at step E68).

A progressive transmission and display of the sub-digital hologram H′ is hence obtained.

In case of positive result at step E70 (i.e. if the position of the observer O has changed), the method continues at step E52 for transmitting the coordinates of the new position of the observer O. In this case, the reiteration of steps E56, E58, notably, will allow new choices and orderings of new blocks T_{h,w} for which descriptive data of the atoms aₘ will be sent.

It can be provided as an alternative that the coordinates (x₀, y₀, z₀) are transmitted periodically from the transmission module 402 of the second electronic device 400 to the receiving module 342 of the first electronic device 300 (without waiting for a potential change of position of the observer O). In this case, the first electronic device 300 is for example designed not to reiterate steps E56, E58 and E60 as long as the position of the observer O is unchanged.

It can moreover be provided to store within the second electronic device 400 the previously received data relating to blocks T_{h,w} in order to use these data when they are required for the reconstruction of the digital hologram H, as seen from the new position of the observer O.

In this case, according to a first possibility, the second electronic device 400 transmits for example to the first electronic device 300 the indices h, w of the blocks T_{h,w} for which data have been received (and are hence stored within the second electronic device 400), as well as possibly an indication of the planes of bits received for each of these blocks T_{h,w}. The first electronic device 300 will not transmit again the so-indicated data.

According to another possibility, a history can be stored within the first electronic device 300, indicating, for each block T_{h,w}, the planes of bits that have already been transmitted to the second electronic device 400 for this block T_{h,w} in such a way that these data are not transmitted again to the second electronic device 400 when the position of the observer O has changed (only the planes of bits completing the description of block T_{h,w} being then transmitted, for example, when this block T_{h,w} is closer to the new position of the observer O, in particular in the embodiment contemplated hereinabove in which the number of planes of bits transmitted is variable as a function of the distance OP_{h,w}).

Of course, various other modifications can be brought to the invention within the framework of the appended claims.

1. A method for transmitting data representative of a digital hologram represented by a plurality of atoms, each of the atoms having a diffraction spectrum in a plane of observation (PO), the method comprising:
determining an order for sets, each said set including at least one of the atoms, the order being determined as a function of a distance, in the plane of observation, between a position of observation and a position associated with a given said set; and
transmitting, for each of at least some of said sets and in the determined order, descriptive data associated with said at least one atom included in said set.

2. The transmission method according to claim 1, further comprising, prior to the determining step, a step of receiving data representative of the position of observation in the plane of observation.

3. The transmission method according to claim 1, wherein each said set includes only one said atom, and wherein the position associated with a given said set is a position of a center of the diffraction spectrum of the atom included in the given said set.

4. The transmission method according to claim 3, wherein the order is further determined as a function of an angular dispersion or an amplitude associated with the atom (aₖ) included in the given set.

5. The transmission method according to claim 3, wherein the descriptive data of the given atom that are transmitted further comprises data representative of the position of the center of the diffraction spectrum of the given atom (aₖ) in a viewing window associated with the position of observation.

6. The transmission method according to claim 1, wherein each said set includes the atoms having a said diffraction spectrum whose center is included in a corresponding region of the plane of observation.

7. The transmission method according to claim 6, wherein the position associated with a given said set is a center of a region corresponding to said given set (T_{h,w}).

8. The transmission method according to claim 6, wherein the descriptive data of a given said atom included in one of the sets include data representative of the position of the center of the diffraction spectrum of the given atom in the region corresponding to the set containing the given atom.

9. The transmission method according to claim 6, further comprising a step of transmitting data representative of a position of said region in the plane of observation.

10. The transmission method according to claim 6, further comprising, prior to the determining step, a step of associating each said atom with the region of the plane of observation containing the center of the diffraction spectrum of said atom.

11. The method according to claim 10, further comprising, for at least one given region of the plane of observation, a step of ordering the atoms associated with said given region as a function of an angular dispersion or an amplitude associated with each of the atoms associated with the given region.

12. A device for transmitting data representative of a digital hologram (H) represented by a plurality of atoms, each of the atoms having a diffraction spectrum in a plane of observation, the device comprising:
a determination module, an output of which is an order for sets, each said set including at least one of the atoms, wherein the order is a function of a distance, in the plane of observation, between a position of observation and a position associated with a given said set; and
a transmission module, a transmitted output of which is, for each of least some of said sets, and in the order output by the determination module, descriptive data of said at least one atom included in said set.

13. The transmission device according to claim 12, further comprising a reception module that is connected to receive data representative of the position of observation in the plane of observation.

14. The transmission device according to claim 12, wherein each said set includes only one said atom, and wherein the order output by the determination module is a function of the distance, in the plane of observation, between a position of observation and the position of the center of the diffraction spectrum of the only one atom included in a given said set.

15. The transmission device according to claim 14, wherein the descriptive data is representative of the position of the center of the diffraction spectrum of a given said at least one atom in a viewing window linked to the position of observation.

16. The transmission device according to claim 12, wherein each said set includes the atoms having a said diffraction spectrum whose center is included in a corresponding region of the plane of observation, and wherein the order output by the determination module is a function of the distance, in the plane of observation, between the position of observation and the center of the region corresponding to a given said set.

17. The transmission device according to claim 16, wherein the descriptive data output by the transmission module is representative of the position of the center of the diffraction spectrum of said at least one atom in the region corresponding to a given said set.

18. The transmission device according to claim 16, further comprising an association module, an output of which is an association for each atom to the region of the plane of observation containing the center of the diffraction spectrum of each atom.

19. A method for receiving data representative of a digital hologram represented by a plurality of Gabor atoms, each of the Gabor atoms having a diffraction spectrum in a plane of observation, the method being performed upon receipt of descriptive data of a given said Gabor atom, the method comprising:
receiving characteristic data of the Gabor wavelet associated with the given Gabor atom and data representative of a position of a center of the diffraction spectrum of the given Gabor atom in the plane of observation; and
determining a position of the given Gabor atom in a plane of the digital hologram as a function of said representative data and said characteristic data.

20. The transmission method according to claim 2, wherein each said set includes only one said atom, and wherein the position associated with a given said set is a position of a center of the diffraction spectrum of the atom included in the given said set.
